(19) United States
(12) Patent Application Publication
(10) Pub. No.: US 2011/0117343 A1
(43) Pub. Date: May 19, 2011

(54) Static Shielding Multilayer Film and Method Thereof

(76) Inventor: Kow Kek Hing, Selangor Darul Ehsan (MY)

(21) Appl. No.: 13/054,264

(22) PCT Filed: Dec. 31, 2008
(86) PCT No.: PCT/MY2008/000200

§ 371 Date: Jan. 14, 2011

(30) Foreign Application Priority Data
Jul. 15, 2008 (MY) UI20082611

(51) Int. Cl. B32B 15/09; B32B 27/36; B32B 27/32

(52) U.S. Cl. 428/213

(57) ABSTRACT

The present invention discloses a low cost static shielding multilayer film (30) which including an innermost skin layer (32). The innermost skin layer (32) is intended to be in contact with an electro-static discharge sensitive component or device. The innermost skin layer (32) is rendered an intrinsically permanent and non-migratory static dissipative property in a co-extrusion process. A non-migratory anti-static chemical additive is added, at a pre-determined concentration, to a bulk resin making up the innermost skin layer (32). This mixture is then extruded to form the innermost skin layer (32). Essentially, the innermost skin layer (32) is included in the film (30) of multiple-layer construction with static shielding and static dissipative properties. Five embodiments are disclosed. The exact number of layers in the multiple-layer construction varies. Like sub-layers are grouped as one layer categorically.

### TECHNICAL FIELD

The present invention relates generally to a film of multiple-layer construction with static shielding and static dissipative properties, more particularly to a film of multiple-layer with a thin innermost skin layer of polymeric material, achieving intrinsically permanent anti-static properties.

### BACKGROUND ART

As electronic devices are getting smaller in sizes (miniaturized) and higher density in their circuit design, they become more electro-static discharge sensitive. Many applications, such as in disk-drive, semi-conductor and wafer fabrication industries, require both clean room environment and static free workstation or electro-static protected areas. Better control of electro-static discharge quality and cleanliness of a static shielding or anti-static film therefore becomes necessary.

An ideal electro-static protective barrier film should be relatively inexpensive, provides electro-static shielding, provides excellent moisture and mechanical barrier and does not contaminate the object being carried and shielded. Particularly when a bag is formed with such a film of multiple-layer construction, the outermost layer is disposed as the outside of the bag. The innermost layer faces the object being carried and shielded inside the bag. For ease of explaining a multiple-layer construction in this specification, the words “outermost”, “intermediate” and “innermost” are used to denote the relative dispositions of the constituent layers making such a film. A constituent layer with static shielding or static dissipative property will generally be called “anti-static”.

In the manufacture of a static shielding film, a three-layer construction commonly includes an intermediate metallic layer (3) as a static shielding layer, being sandwiched in between at least two polymeric layers (1, 4) including polyolefin layers. This intermediate metallic layer is sometimes repeated to achieve better physical properties like moisture barrier, strength, gas barrier and so on. Furthermore, both sides of the film (in other words, the outermost and the innermost layers) are often rendered static dissipative, so that static charges are conducted away when the film is grounded.

According to prior art knowledge, hygroscopic migratory chemical additives are first added to palletized polyolefin bulk resin. These mixture components are then extruded in a standard film blowing machine to form a polyolefin layer or film. This is known as the anti-static (or more precisely static dissipative) impregnated method. The additives will slowly migrate to the surfaces of the film and absorb moisture in the air to form a molecular layer of water which conducts away the static charges on its surface. Thus, a migratory electro-static discharge property is rendered. However, it is important to note that migration of the additives through an intermediate adhesive layer will simultaneously take place. This will gradually soften the adjacent intermediate adhesive layer over time. This causes serious de-lamination problem, leading to product defect, heavy inventory losses and great financial damage. This occurs usually within one to six months of storage depending on the type of additives and bulk resin used.

As disclosed in United States Patent Application Publication No. 20050037217 (application Ser. No. 10/500,740), the innermost layer (1) is a sealable polyolefin material as shown in FIG. 1a. Its exposed side (5) is coated with an anti-static (or more precisely static dissipative) chemical, resulting in a non-charging layer. This coating process essentially consists of a mono-molecular layer of surface coating. It becomes conductive by OH− and H+ ion generation. This method eliminates the de-lamination problem of the above anti-static impregnated method. However, this anti-static coating is not intrinsically permanent. This coating can be readily and easily wipe off or wash away with a normal wet cloth. Its anti-static (or static dissipative) property also deteriorates for repeated uses of the film. Furthermore, this coating gives rise to cross-contamination, as it is the source for non-volatile residue and volatile ionic contamination. This coating is undesirable especially in disk-drive or wafer fabrication industries.

To eliminate the above migratory issue and the cross-contamination problem, the coated polyolefin layer can be substituted by a permanently anti-static or static dissipative material which is non-migratory. According to Chinese Patent Application Publication No. CN101045804A (Application No. 200610067408.6) as shown in FIG. 1b, a 100% volumetric layer of intrinsically anti-static polyolefin is used as a sealable base layer (6). This base layer (6) can technically overcome the problems associated with permanency of anti-static property, de-lamination, and contamination due to migratory additives and so on.

However, the cost of the sealable polyolefin layer as the innermost or base layer as highlighted in Chinese Patent Application Publication No. CN101045804A is too expensive. Commercialization of such new material is more difficult and its marketability is limited.

To those skilled in the art, it will be obvious to reduce the thickness of the innermost or base layer made of normal non-anti-static polyolefin material and to laminate on it a thin non-migratory anti-static layer. However, it is difficult to control its tension while lamination. Furthermore, the thin layer must be even and free from wrinkles. The need for a low cost intrinsically anti-static (i.e. static shielding and static dissipative) film gives rise to further experimentation and research works, leading to the present invention.

US patent publication no. US2008/0213607 discloses an antistatic multilayer sheet with coat layers constituted of a transparent resin and substantively do not contain a polymeric antistatic agent, and at least one antistatic layer constituted of a transparent resin and a polymeric antistatic agent. The antistatic layer is in contact with the inside of the coat layer and the coat layers are placed on the outermost faces of the multilayer sheet. However, this prior art does not has any inventive element on conductive or shielding property. Thus, without the electrostatic shielding property, it would not meet the requirement of ANSI S20.20 (US) static control guideline for transporting electrostatic discharge sensitive devices outside the electrostatic protected area.

U.S. Pat. No. 6,197,486 discloses a reflection photographic imaging material with at least one silver halide layer, a support with at least one extruded layer formed integrally with the support with a polymeric antistatic material. Similarly, this prior art highlights the photographic imaging material application has no shielding element where no electrostatic shielding capability as required.

U.S. Pat. No. 6,197,486 discloses a laminated sheet material adaptable for forming a package for containing electrostatically sensitive components having a first inner layer of a coextruded film having a polyolefin ply and a copolymer ply selected from the group consisting of ethylene-acrylic acid copolymers, ethylene-vinyl acetate copolymers and blends thereof, a second intermediate layer having an electrically conductive material deposited thereon laminated to the first inner layer and adjoining said copolymer ply, and an outer layer of an antistatic material, said opposite said first inner layer. However, this prior art utilizing electron beam method where antistatic chemical coated on one side and migrate to the other side through the activation of electron beam. This method unable to achieve a uniform electrical resistivity between coated surface and the opposite surface with a typical ten times electrical resistance value differentiation. This method also involves high cost of production.

EP Patent No. 0408013 discloses a packaging material for photosensitive material which is a multilayer film comprising two coextruded multilayer inflation films of which antistatic agent content (wt. %) of the outer layer is more than 1.2 times as large as antistatic agent content (wt. %) of the inner layer. This prior art employs the antistatic migratory technology which is not only difficult to control, it is also difficult to predict the shelf-life due to various storage condition like duration, temperature, RH etc. This invention also does not has the capability to provide electrostatic shielding which is important for the protection of electrostatic sensitive microchip.

### SUMMARY OF THE INVENTION

The present invention has therefore as a primary object to provide a static shielding multilayer film with an innermost skin layer, made from polymeric material, and achieving a low cost intrinsically permanent anti-static property.

This primary object is achieved firstly in that the innermost skin layer in the film of multiple-layer construction is relatively thin, and is attached to an adjacent polymeric layer, forming a base layer. This innermost skin layer is rendered an intrinsically permanent and non-migratory static dissipative property from an extrusion process, including a single film blowing process or an extrusion coating process. A non-migratory anti-static chemical additive is added, at a pre-determined concentration, to a bulk resin making up the innermost skin layer. The bulk resin, for the innermost skin layer and the polymeric layer, is selected from the polyolefin group including linear low density polyethylene, low density polyethylene, medium density polyethylene, high density polyethylene, ethylene vinyl acetate, ethylene vinyl alcohol and polypropylene. The skin layer constitutes a fraction of the total thickness of the base layer and the skin layer.

As taught by the present invention, exact number of layers in the multiple-layer construction may vary. Like sub-layers are grouped as one layer categorically. Hence, five preferred embodiments of the multiple-layer construction according to the present invention are broadly called six-layer or seven-layer. However, in any variation of the multiple-layer construction, the essence of the present invention is to provide this innermost intrinsically permanent anti-static or static dissipative skin layer to the multiple-layer construction.

### BRIEF DESCRIPTION OF THE DRAWINGS

FIG. 1a shows a prior art film of six-layer construction according to United States Patent Application Publication No. 20050037217.

FIG. 1b shows a prior art film of five-layer construction according to Chinese Patent Application Publication No. CN101045804A.

FIG. 2 shows a prior art bag constructed from a film of three-layer construction, where static charges are shielded by a metallic layer and dissipated by an anti-static topical coating.

FIG. 3a shows a first embodiment of the present invention.

FIG. 3b shows a second embodiment of the present invention.

FIG. 3c shows a third embodiment of the present invention.

FIG. 3d shows a fourth embodiment of the present invention.

FIG. 3e shows a fifth embodiment of the present invention.

### DETAILED DESCRIPTION

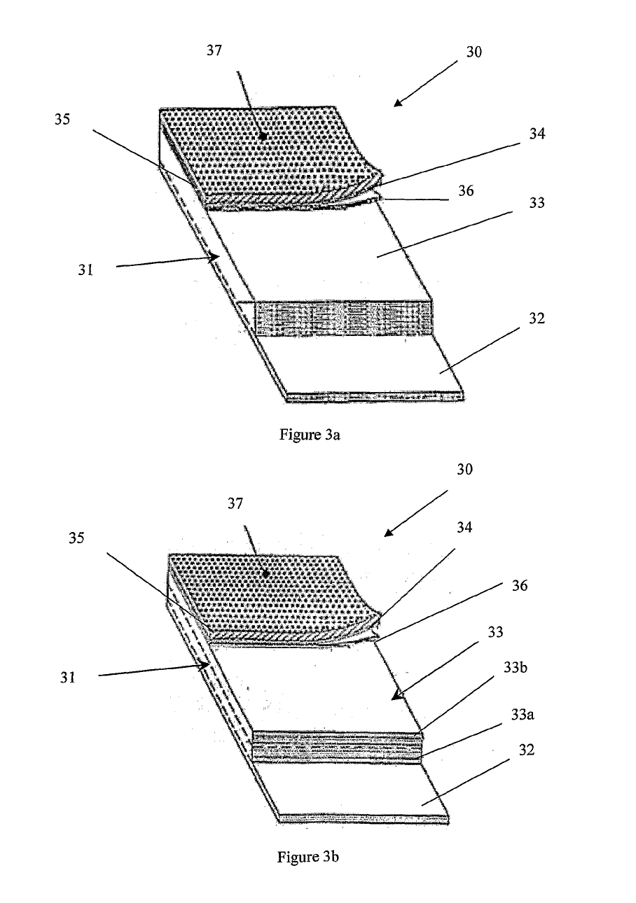

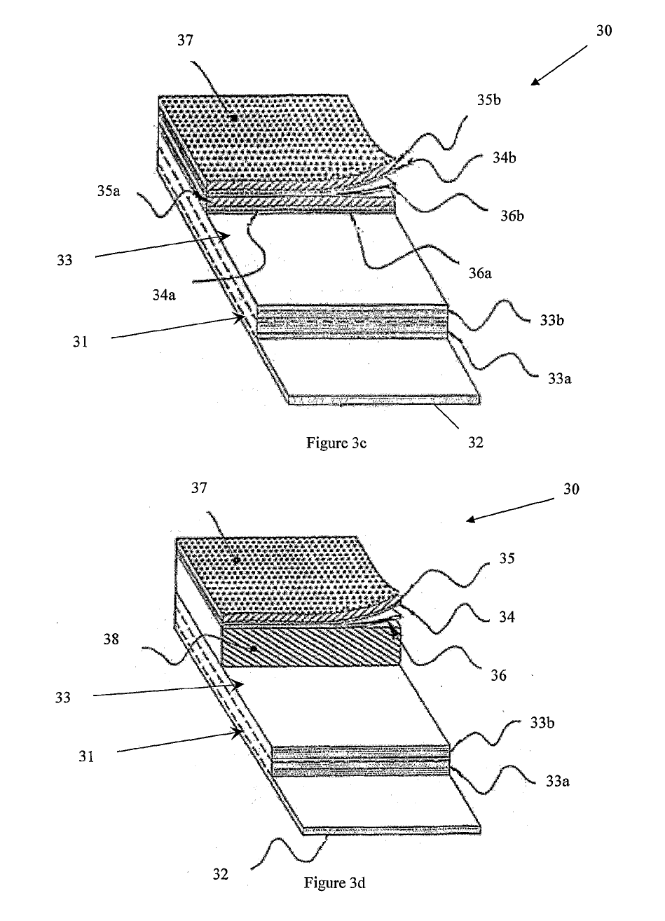

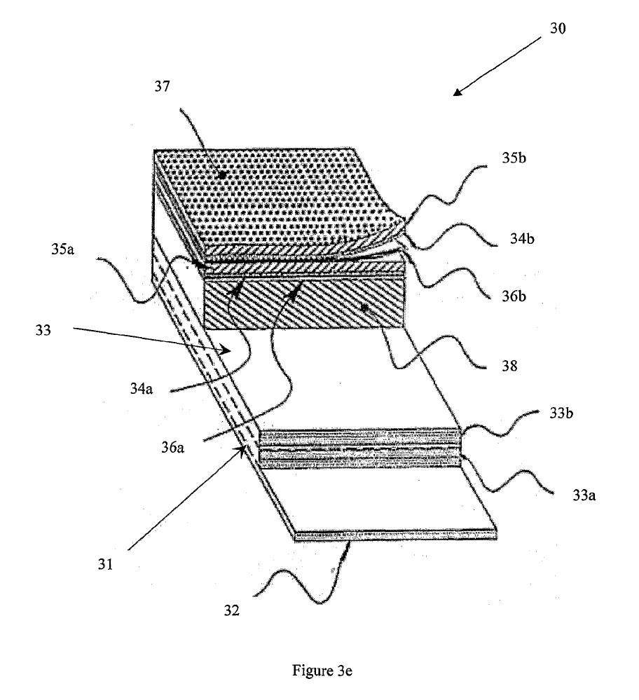

In order that the present invention may be readily understood, the following detailed description is given, by way of example, of five specific embodiments of a low cost film of multiple-layer construction with static shielding and static dissipative properties, made in accordance with the present invention. Reference will be made to the accompanying drawings, FIGS. 3a to 3e.

Same numerals are used to denote like layers in the embodiments of the present invention. To denote differentiation of like sub-layers, suffices “a” and “b” are added after the same numerals denoting the like layers.

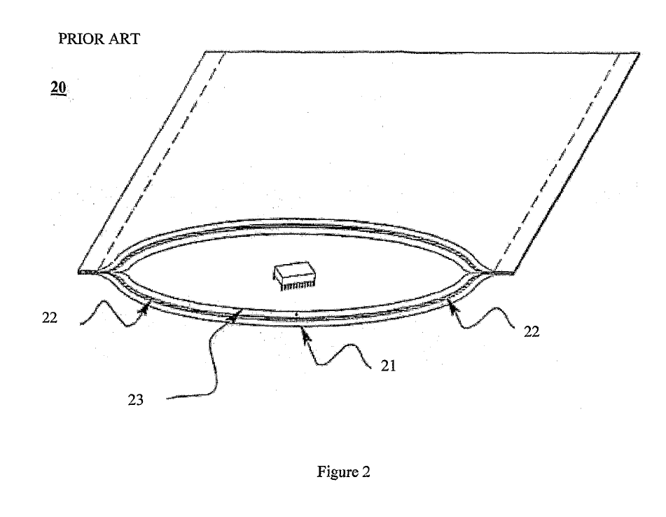

A prior art packaging material in the form of a bag (20) is illustrated in FIG. 2. Essentially, it shows an electro-static discharge film of three-layer construction. The outermost layer is a polyester layer (21) with a static dissipative topical coating to render it anti-static. The intermediate static shielding layer is a metallic layer (22) which is commonly known as Faraday Cage. The innermost layer is an anti-static polyolefin base layer (23). The outermost polyester layer (21) is less critical to electro-static discharge damage protection. Even if there are pockets of static charges, the static charges will not penetrate through the Faraday Cage, to cause electro-static discharge damage to the components and devices carried inside the bag. The innermost anti-static polyolefin base layer (23) comes in contact with the electro-static discharge sensitive components and devices. It is much more critical to static charge accumulation. A multiple-layer construction is therefore known in the manufacture of an anti-static film with static shielding and static dissipative properties.

Referring now to FIG. 3a, the present invention is a static shielding multilayer film (30) comprises a base layer (31) which is formed by an innermost skin layer (32) and a polymeric layer (33), a metallic layer (34) and a polyester layer (35). The innermost skin layer (32) utilizes only a fraction of the total thickness of the base layer (31), and thus enables the static shielding multilayer film (30) of the present invention to be manufactured inexpensively to achieve low cost commercial viability. Chemical additives including a non-migratory anti-static chemical additive is added to bulk resin making up the innermost skin layer (32), to achieve premium properties, such as high seal strength, low sealing temperature and so on, at low cost. The basic physical properties such as tensile strength, elongation at break and so on will not be affected by the innermost skin layer (32). This innermost skin layer (32) structure will provide its adjacent sub-layers more room in design flexibility. Low cost filler or recycled material or a more economical resin can be incorporated into its adjacent sublayers.

The present invention achieves a commercial breakthrough in terms of cost saving, superior anti-static properties and high commercial marketability.

The following five embodiments of the present invention illustrate the relative dispositions of constituent layers in making up static shielding multilayer film with anti-static properties. FIG. 3a shows a first embodiment of the present invention. A six-layer construction is shown, where the innermost skin layer (32) is an intrinsically permanent static dissipative layer. This innermost skin layer (32) is also made of polymeric material.

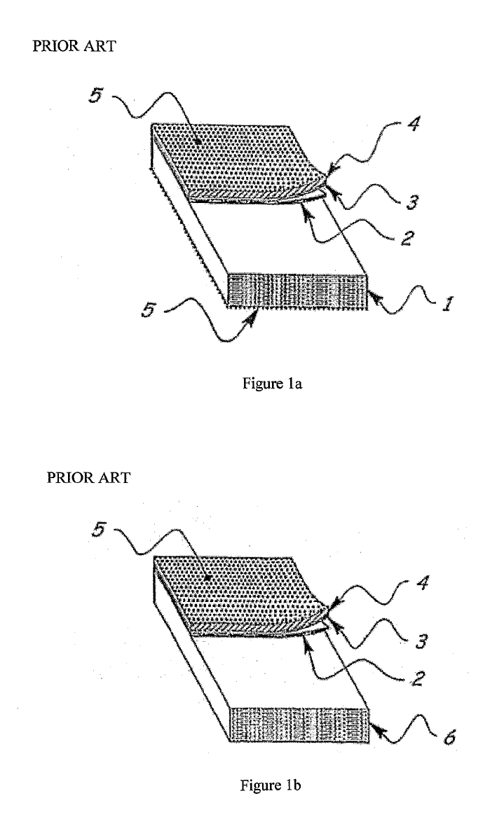

The polymeric material for the base layer (31) of innermost skin layer (32) and polymeric layer (33) is selected from a group consisting of linear low density polyethylene, low density polyethylene, medium density polyethylene, high density polyethylene, ethylene vinyl acetate, ethylene vinyl alcohol and polypropylene. The surface of the innermost skin layer (32) is rendered permanently anti-static. Incorporation of chemical additives (for an example, a trade name Pelestat manufactured by Sanyo) at 5 to 20% concentration will give the desired permanent anti-static property of approximately 10⁷ to 10¹¹ ohm. Preferably, a concentration of 8 to 12% concentration is preferred to give a permanent anti-static property of approximately 10⁹ to 10¹⁰ ohm (measured as per ANSI/ESD S11.11). This innermost skin layer (32) is in the range of approximately 3 to 25 micron thick. This thickness constitutes only in the range of 3 to 15% of the total thickness of the base layer (31). This reduces the amount of anti-static chemical additives used, which drastically reduces the manufacturing cost in contrast to Chinese Patent Application Publication No. CN101045804A shown in FIG. 1b.

Furthermore, the innermost skin layer (32) is preferably co-extruded from at least two sub-layers of similar or different materials in a single film blowing extrusion machine. Alternatively, single coat can be repeatedly applied from an extrusion coating machine to build up to a desired thickness of a layer, with the last coat being a ‘skin’ layer of intrinsically permanent anti-static or static dissipative polyolefin composition. This co-extruded composite base layer (31) has a total thickness in the range of 20 to 120 micron.

The surface layer without any permanent antistatic material of the base layer is then attached to an adhesive layer (36). The adhesive layer (36) is preferably polyurethane based adhesive, but may be a hot melt polymer such as polyethylene. The adhesive layer (36) is then attached to the metallic layer (34) and the metallic layer (34) attached to the polyester layer (35). Metallization of the metallic layer (34) is by vapor depositing a layer of metal in a vacuum controlled condition onto a polymeric support structure. Material for the metallic layer (34) is selected from a group consisting of aluminum, titanium, magnesium, copper, nickel, chromium or zincs. Aluminum is preferably chosen, because of its relative low cost and easy handling characteristics. Material for the polymeric support structure is preferably chosen from a group consisting of polyethylene terephthalate, polyester, polypropylene, polyvynilydene fluoride and polycarbonate. In this description, polyester is chosen. Preferably, the metallized surface is oriented towards the adhesive layer (36).

An outermost topical coating (37) uses static dissipative chemical is coated onto the polyester layer (35). The topical coating (37) is not made intrinsically permanent as it is not in contact with the object to be shielded. Through wear and tear, there will be pockets of static charges on the topical coating (37). The charges will not penetrate through the Faraday Cage. Such a unique protection was previously explained and illustrated in FIG. 2. Such use of the topical coating (37) greatly reduces the cost of manufacturing an anti-static film, while maintaining a satisfactory static dissipative effect at the outermost layer.

FIG. 3b shows a second embodiment of the present invention. It is essentially a six-layer construction, where the innermost skin layer (32) is an intrinsically permanent static dissipative layer.

In order to increase the mechanical strength of the film (30), the polymeric layer (33) is made from two sub-layers (33a, 33b). The polymeric layer (33) is a polyolefin layer. These sub-layers (33a, 33b) of the polymeric layer (33) are sandwiched between the innermost skin layer (32) and the adhesive layer (36).

The polymeric material for the polymeric layer (33) with sub-layers (33a, 33b) is selected from a group consisting of linear low density polyethylene, low density polyethylene, medium density polyethylene, high density polyethylene, ethylene vinyl acetate, ethylene vinyl alcohol and polypropylene. The number of the sub-layers (33a, 33b) is not limited to two layers as shown in FIG. 3b.

In the second embodiment of the present invention, the essence of using an intrinsically permanent static dissipative skin layer (32) as its innermost layer is maintained, to provide excellent static dissipative property at low cost.

FIG. 3c shows a third embodiment of the present invention. It is essentially an eight-layer construction, with an intrinsically permanent static dissipative skin layer (32) as the innermost layer.

Film construction in the third embodiment is essentially similar to that of the second embodiment, except with an additional set of metallic layer (34) and polyester layer (35). In the third embodiment, the interest is to further increase the electro-magnetic protection, moisture barrier and mechanical strength of the film (30). A second set of metallic layer (34b) and polyester layer (35b) is attached to a second adhesive layer (36b). This second set is further attached to the first set of metallic layer (34a) and polyester layer (35a) and the first adhesive layer (36a). Materials for the polyester layer (35), metallic layer (34) and adhesive layer (36) are the same as the first embodiment. The anti-static topical coating (37) is then applied on the second polyester layer (35b). It is to be understood that at least two sets of metallic layer (34) and polyester layer (35) can thus be included.

Again, in this third embodiment, the essence of using an intrinsically permanent static dissipative skin layer (32) as the innermost layer is maintained, together with the flexibility of other structural modification.

FIG. 3d shows a fourth embodiment of the present invention. Essentially, it is a seven-layer construction, with an innermost intrinsically permanent static dissipative skin layer (32). Film construction in the fourth embodiment is essentially similar to that of the second embodiment, except for an additional polymeric layer (38). In this fourth embodiment, the primary objective is to further increase the mechanical strength protection capability of the film. Therefore, at least one polymeric layer (38) can be added into the film (30). This additional polymeric layer (38) is sandwiched in between the polymeric layer (33) with sub-layers (33a, 33b) and the adhesive layer (36).

Material for the polymeric layer (38) is chosen from the polyolefin group consisting of linear low density polyethylene, low density polyethylene, medium density polyethylene, high density polyethylene, ethylene vinyl acetate, ethylene vinyl alcohol and polypropylene.

Again, in this fourth embodiment, the essence of using an intrinsically permanent static dissipative skin layer (32) as the innermost layer is maintained, together with other structural modification.

FIG. 3e shows a fifth embodiment of the present invention. Essentially, it is a nine-layer construction, with an innermost intrinsically permanent static dissipative skin layer (32).

Film construction in the fifth embodiment is essentially similar to that of the fourth embodiment, except with an additional set of metallic layer (34) and polyester layer (35). In the fifth embodiment, the primary objective is to further increase the electro-magnetic protection, moisture barrier and mechanical strength of the film (30). Therefore, a second set of metallic layer (34b) and polyester layer (35b) has been added. The second set of metallic layer (34b) and polyester layer (35b) can be attached with the assistance of a second adhesive layer (36b). The second adhesive layer (36b) is further attached to the first set of metallic layer (34a) and polyester layer (35a). Materials for the polyester (35), metallic (34) and adhesive (36) layers are the same as that of the first embodiment.

The anti-static topical coating (37) is applied on the second set of polyester layer (35b) and metallic layer (34b). If required, more sets of polyester layer (35) and metallic layer (34) can be added.

Essentially, one polymeric layer (38) is attached in between the first adhesive layer (36a) and the polymeric layer (33) with sub-layers (33a, 33b). Materials for the polymeric layer (38) are similar to that as described in the fourth embodiment. It is to be noted that at least one polymeric layer (38) can be added.

In the fifth embodiment, the essence of using an intrinsically permanent static dissipative skin layer (32) as the innermost layer is maintained, together with other structural modification. According to the present invention, the static shielding multilayer film as described in the above five embodiments can be transparent, opaque or translucent depending on the number of layers and materials chosen. Though the present invention has thus been described with reference to some preferred embodiments thereof, it will be obvious to those skilled in the art that the present invention is not particularly limited thereto but can be changed or modified in various manners without departing from the scope thereof. Regardless of the variation, one essence of the present invention lies in maintaining an intrinsically permanent static dissipative innermost skin layer (32) which will provide excellent static dissipative protection at low cost.

Intrinsically permanent static shielding films thus produced from this invention can be used as medical packaging films, pharmaceutical seal-peel (easy peel) films, or ultra clean-room films in the electronics, medical, pharmaceutical and other high technology industries and so on.

1. A static shielding multilayer film (30) comprising:
a base layer (31) which is formed by an innermost skin layer (32) and a polymeric layer (33);
an adhesive layer (36) attached to said base layer (31) onto said polymeric layer (33);
a metallic layer (34) attached to said adhesive layer (36);
a polyester layer (35) attached to said metallic layer (34); and
an outermost topical coating (37) with static dissipative chemical coated onto said polyester layer (35), characterized in that said innermost skin layer (32) of said base layer (31) is formed into a fraction of a total thickness of said base layer (31) and is rendered an intrinsically permanent and non-migratory static dissipative property by incorporation of a non-migratory anti-static chemical additive into a bulk resin making up said innermost skin layer (32).

2. The static shielding multilayer film (30) as claimed in claim 1, wherein said chemical additive is Pelestat.

3. The static shielding multilayer film (30) as claimed in claim 2, wherein said chemical additive is added to said bulk resin at approximately 5 to 20 percent concentration to obtain approximately 10⁷ to 10¹¹ ohm of permanent anti-static property.

4. The static shielding multilayer film (30) as claimed in claim 3, wherein said chemical additive is preferably added to said bulk resin at approximately 8 to 12 percent concentration to obtain approximately 10⁹ to 10¹⁰ ohm of permanent anti-static property.

5. The static shielding multilayer film (30) as claimed in claim 4, wherein said bulk resin is selected from the polyolefin group including linear low density polyethylene, low density polyethylene, medium density polyethylene, high density polyethylene, ethylene vinyl acetate, ethylene vinyl alcohol and polypropylene.

6. The static shielding multilayer film (30) as claimed in claim 1, wherein said innermost skin layer (32) is formed with its thickness of approximately 3 to 25 micron.

7. The static shielding multilayer film (30) as claimed in claim 1, wherein said polymeric layer (33) is a polyolefin layer.

8. The static shielding multilayer film (30) as claimed in claim 1, wherein said adhesive layer (36) is preferably a polyurethane based adhesive.

9. The static shielding multilayer film (30) as claimed in claim 1, wherein said adhesive layer (36) may be a polyethylene based adhesive.

10. The static shielding multilayer film (30) as claimed in claim 1, wherein said metallic layer (34) having its metallization formed by vapor deposition of a layer of metal in a vacuum controlled condition onto a polymeric support structure.

11. The static shielding multilayer film (30) as claimed in claim 10, wherein said layer of metal for said metallic layer (34) is selected from a group consisting of aluminum, titanium, magnesium, copper, nickel, chromium or zincs.

12. The static shielding multilayer film (30) as claimed in claim 11, wherein said layer of metal for said metallic layer (34) is aluminum.

13. The static shielding multilayer film (30) as claimed in claim 12, wherein said layer of metal of said metallic layer (34) is oriented towards the adhesive layer (36)

14. The static shielding multilayer film (30) as claimed in claim 10, wherein said polymeric support structure is selected from a material group co consisting of polyethylene terephthalate, polyester, polypropylene, polyvynilydene fluoride and polycarbonate.

15. The static shielding multilayer film (30) as claimed in claim 14, wherein said polymeric support structure is made of polyester.

16. The static shielding multilayer film (30) as claimed in claim 7, wherein said polymeric layer (33) could be formed with two sub-layers (33a, 33b) and sandwiched between said innermost skin layer (32) and adhesive layer (36) of said film (30).

17. The static shielding multilayer film (30) as claimed in claim 16, wherein said polymeric layer (33) with sub-layers (33a, 33b) is selected from a group consisting of linear low density polyethylene, low density polyethylene, medium density polyethylene, high density polyethylene, ethylene vinyl acetate, ethylene vinyl alcohol and polypropylene.

18. The static shielding multilayer film (30) as claimed in claim 16, wherein said film (30) further comprising an additional polymeric layer (38) sandwiched in between said polymeric layer (33) with sub-layers (33a, 33b) and said adhesive layer (36).

19. The static shielding multilayer film (30) as claimed in claim 18, wherein said film (30) further comprising an additional set of a second metallic layer (34b) attached to a second adhesive layer (36b) and a second polyester layer (35b) attached to said second metallic layer (34b), said additional set of layers is attached onto said polyester layer (35) of the film (30).

20. The static shielding multilayer film (30) as claimed in claim 19, wherein said film (30) further comprising an additional polymeric layer (38) sandwiched in between said polymeric layer (33) with sub-layers (33a, 33b) and said adhesive layer (36) of the film (30).

21. The static shielding multilayer film (30) as claimed in claim 1, wherein said base layer (31) is co-extruded from at least two sub-layers of similar or different materials in a single film blowing extrusion machine to form a co-extruded composite base layer (31).

22. The static shielding multilayer film (30) as claimed in claim 21, wherein said co-extruded composite base layer (31) has a total thickness in the range of 20 to 120 micron.

23. The static shielding multilayer film (30) as claimed in claim 1, wherein said base layer (31) could be formed with a single coat repeatedly applied from an extrusion coating machine to build up to a desired thickness of a layer, with the last coat being a ‘skin’ layer of intrinsically permanent anti-static or static dissipative polyolefin composition.
